(19) United States
(12) Patent Application Publication
(10) Pub. No.: US 2014/0312551 A1
(43) Pub. Date: Oct. 23, 2014

(54) Clamp-it-Once

(71) Applicant: Jeffrey Nicholas Kress, Hales Corners, WI (US)

(72) Inventor: Jeffrey Nicholas Kress, Hales Corners, WI (US)

(21) Appl. No.: 14/256,738

(22) Filed: Apr. 18, 2014

Related U.S. Application Data
(60) Provisional application No. 61/817,321, filed on Apr. 30, 2013.

(51) Int. Cl. B23Q 3/06

(52) U.S. Cl. CPC B23Q 3/06
USPC 269/91

(57) ABSTRACT

I designed the Clamp-it-Once fixture as a work holding device as a better version of an angle plate. Clamp-it-Once is used for grinding, inspection or machining components square.

It's design and components are extremely simple and basic, but radically different than other work holding devices currently being used.

Because the main block is square without an inside angle or corner, it has more stability, increasing accuracy. The clamps are very close to the work piece providing direct force on the component securing the work piece with superior force. The clamps are inboard of the block eliminating the step of having to switch clamps; for example the grinding of the 2^{nd} side (90 deg. side of a component). Upon release of the clamps, they remain stationary for multiple pieces to be worked on.

The Clamp-it-Once fixture is much easier to set-up both the main block and the work piece are lying down fully supported while setting up until it is clamped and secure. The old traditional way one would have to hold up the work piece and maintain it in place then position an external clamp to secure it. This is awkward, cumbersome and generally heavier than Clamp-it-Once. When the work piece is securely clamped, your component is ready to be ground, machined or inspected, complete first side, remove the fixture, turn the fixture 90 degrees and you are ready to complete the second side without having worry about the component moving or having to reclamp it. I would like to emphasize the 1/4-20 tapped holes and threaded rod are immaterial to the patent; (they could be any size). I am looking to patent the clamping mechanism itself regardless of the tapped hole size.

The Clamp-it-Once fixture is a very simple work holding device consisting of nine components.
1.) The main block is a piece of A-2 tool steel (2 ¼″×6″×6″) with 221 ¼-20 tapped holes per side. Manufactured component. (1 piece)
2.) Two strap clamps made out of 4140 pre-hard steel with an elongated slot for clearance and travel with a ¼-20 socket head cap screw.
   Manufactured components. (2 pieces)
3.) Four sets of ¼-20 threaded rod made out of 4140 pre-hard steel of lengths starting at 2″ up to 5″ in one inch increments. Purchased hardware. (8 Pieces)
4.) Black oxide washers with clearance for the ¼″screw. Purchased hardware.
   (2 Pieces)
5.) Socket head cap screws with a ¼-20 thread starting at 1″ length up to 4″ in ¼″ increments. Purchased hardware. (26 Pieces)
   I would like to emphasize the ¼-20 tapped holes and threaded rod are immaterial to the patent; (they could be any size). I am looking to patent the clamping mechanism itself regardless of the tapped hole size.

### Clamp-It Once Fixture's Uses

The Clamp-It-Once fixture is a work holding device. It is used to securely clamp a component in position for machining or inspection purposes.

### How Is Clamp-It-Once a Better Product

The Clamp-It-Once fixture is better product than the standard angle plate because its design gives the fixture SIX main advantages.
1.) The Clamp-It-Once Fixtures design does not have an inside angle to flex. (Example. Angle Plate) Being a square block increases its stability, accuracy and is made from a quality tool steel.
2.) The Clamp-It-Once Fixture is faster because you do not have to take the time to switch clamps for grinding the second side and you are not taking a chance the piece moves in the process of switching clamps. (hence the name Clamp-It-Once)
3.) The Clamp-It-Once Fixture is a complete system therefore is cheaper than buying an angle plate and a variety of external clamps, because angle plates are useless without clamps.
4.) The Clamp-It-Once Fixture is not cumbersome or awkward to set-up or use, because you set it down on the surface plate, put your piece on top and clamp it with the smaller, lighter in-board clamps vs. the angle plate of having to hold your piece or support it and put the heavier awkward external clamps on.
5.) With the Clamp-It-Once Fixture the clamps remain stationary upon release, another feature that makes it easier to set-up and use, especially for multiple pieces.
6.) The Clamp-It-Once design enables the clamps to be very close to the work piece (direct) making the clamping force very strong, secure and stable. The traditional way of clamping uses external clamps with the force of the clamping mechanism quite a distance away from the workpiece which reduces its holding power.

### HOW TO MAKE THE CLAMP-IT-ONCE FIXTURE

BLOCK—Start with A-2 Tool Steel
1.) Stock is saw cut (oversize) to 2.25×6×6 inches from steel supplier.
2.) Mill sawed edges to approximate size.
3.) Drill and tap 221 ¼-20 threaded holes each side.
4.) Heat treat the block to 58-60 Rockwell C Scale (R/C).
5.) Grind block Square (finish size).
6.) Deburr.
7.) 1 Pc.

Clamp—4140 prehard steel
1.) Saw cut bar stock to 3.125 inch length.
2.) Mill 3.00 inch length to size.
3.) Drill and tap one ¼-20 hole 5/16 from the back of the clamp.
4.) Mill a 0.260 wide slot by 1.63 long centered in clamp.
5.) Mill two 15 degree angles on the front of the clamp.
6.) Deburr
7.) 2 Pcs.

Purchased Items:
1.) ¼-20 Socket Head Cap Screws (SHCS) in increments of 0.25 up to 4.0 inches (Unbrako—Tensile strength 180 k-190 k psi). (26 Pcs. Purchased)
2.) Cut ¼-20 Threaded Rod in increments of 1.0 inch up to 6.0 inches (AISI C-1010 to 1020 steel Minimum tensile strength 60 k psi). (6 pcs.)
3.) 0.25 inch I.D. Washers (Flat, Hardened and Black Oxidized). (2 pcs. Purchased)

### Print Descriptions

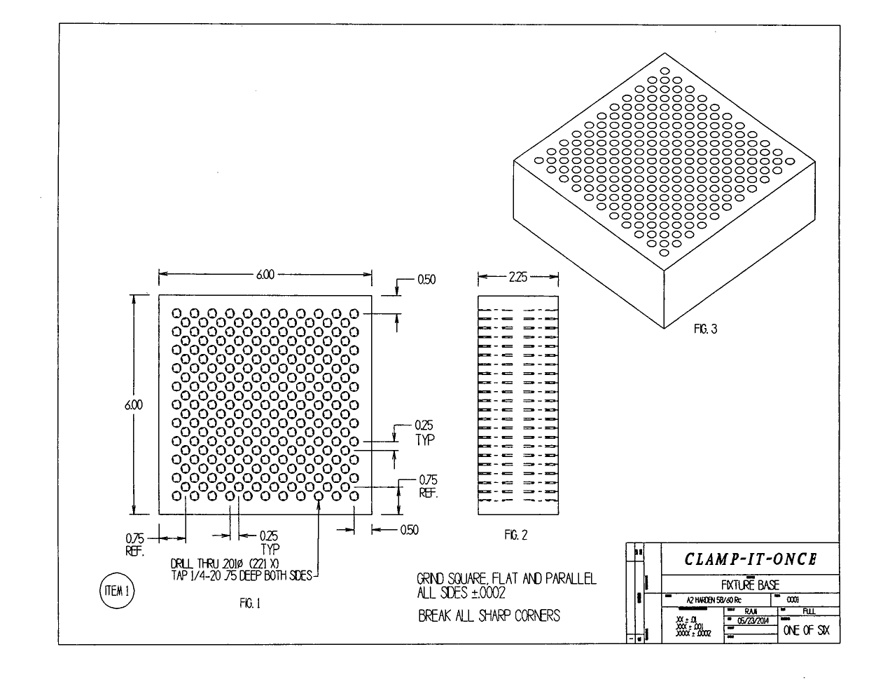

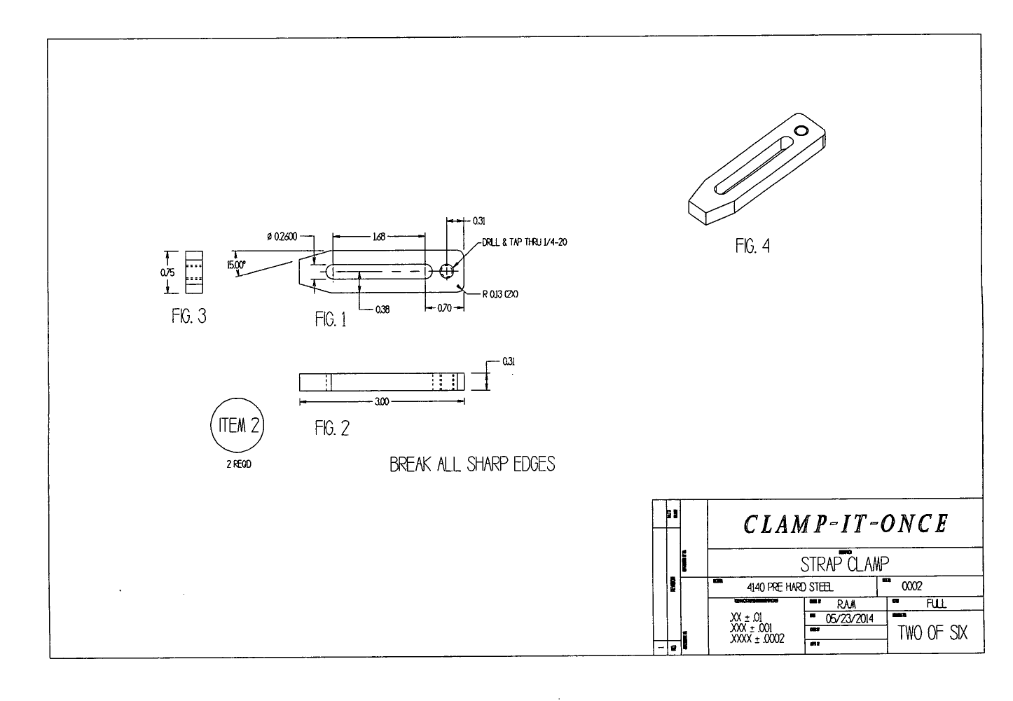

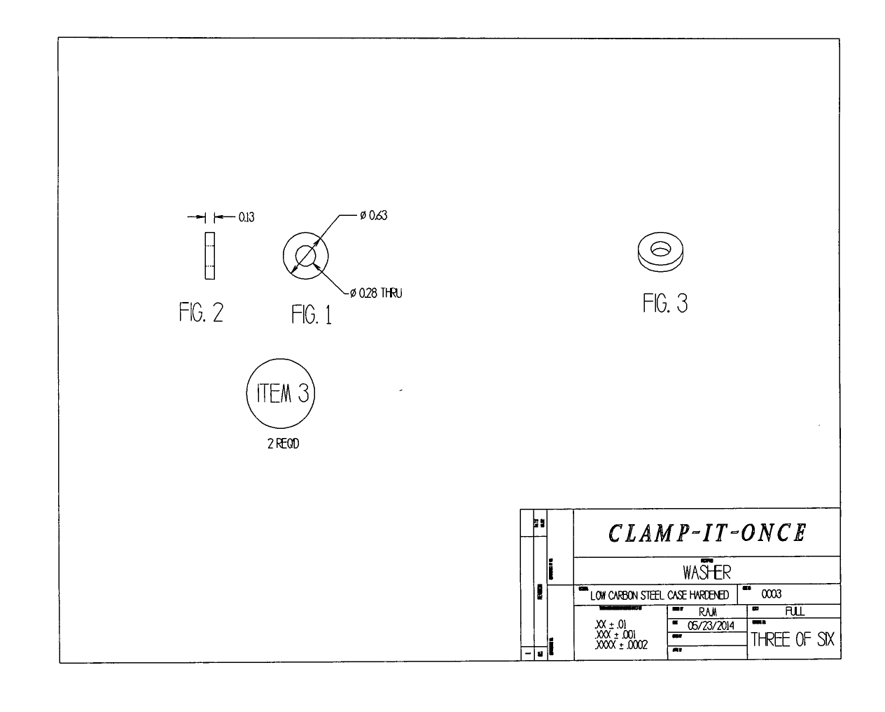

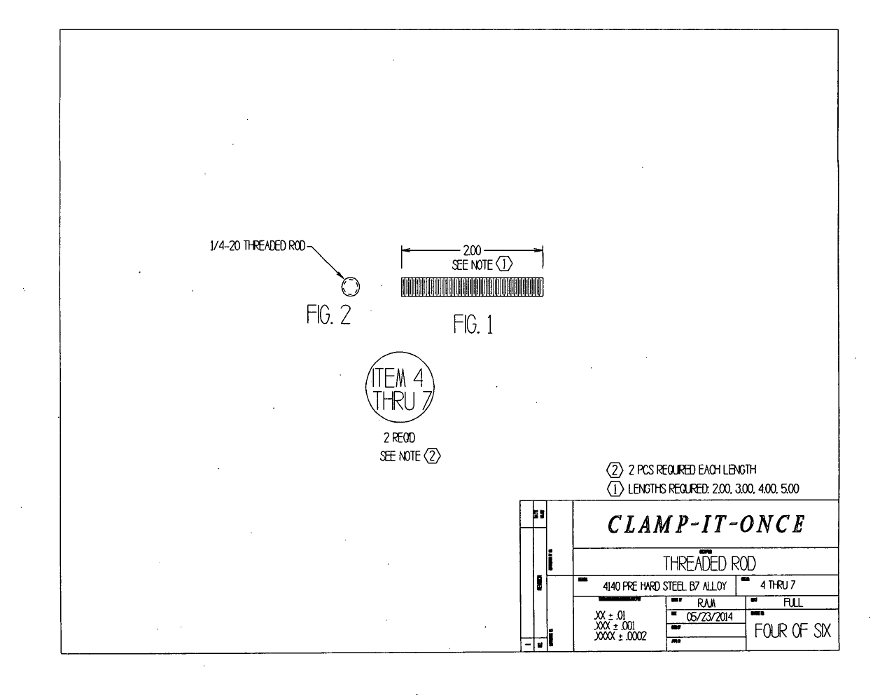

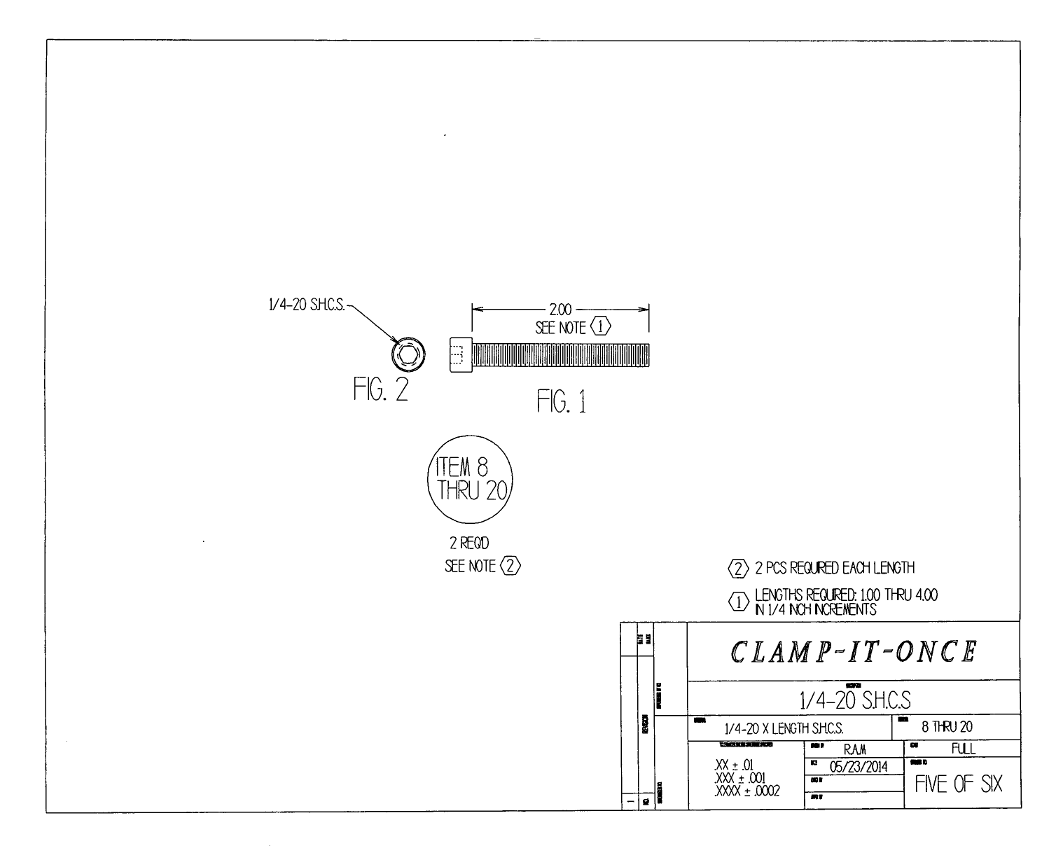

1.) Drawing #1—Item #1 Fixture Base (1 required)
a.) FIG. 1 is the top view showing the length and width dimensions at 6×6 inches. The top view is showing placement of the 221 tapped holes (442 total tapped holes from the top and bottom). The note in FIG. 1 is designating the 0.221 drilled holes as thru the block and the tap depth is 0.75 inches from the top and bottom surface.
b.) FIG. 2 is the side view showing thickness of the base at 2.25 inches. The side view is showing the 0.201 tap drill hole thru the base block and the threaded hole 0.75 inches deep from the top and bottom surface.
c.) FIG. 3 is the three dimensional view of the fixture base.
d.) The notes are instructions for the grinding specifications regarding flatness, squareness (90 degree edges) and parallelism to be within 0.0002 of an inch and sharp corners are to be broke.

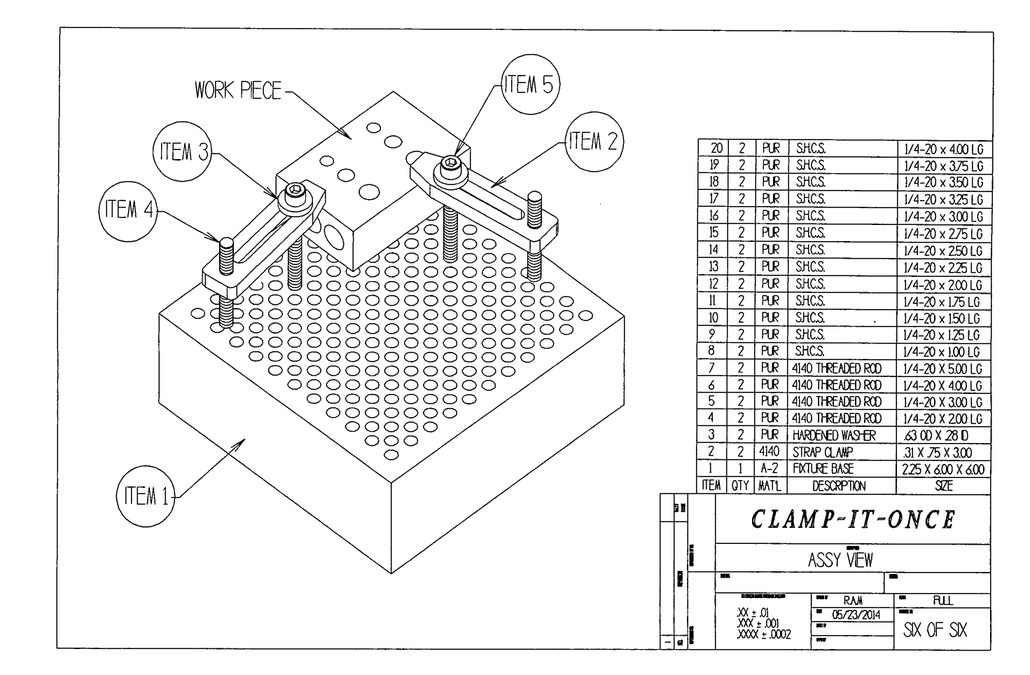

2.) Drawing #2—Item #2 Strap Clamp (2 required)
a.) FIG. 1 is the top view showing length and width contours. The top view shows the feature dimensions of the slot, tapped hole and the tapered end of the clamp.
b.) FIG. 2 is the front view showing thickness (0.31 inches), length (3.00 inches). The solid lines show the beginning edge of the taper at the front end of the clamp and the radius corners at the back end of the clamp. The hidden lines show the tapped hole and slot as thru the clamp.
c.) FIG. 3 is the left side view showing the clamps width at 0.75 inches. The solid lines show the end of the taper on the front of the clamp. The hidden lines show the tapped hole and the slot as thru the clamp.
d.) FIG. 4 is the three dimensional view of the strap clamp.

3.) Drawing #3—Item #3 Washer (2 required)
a.) FIG. 1 shows the outside diameter at 0.63 of an inch and the inside diameter at 0.28 of an inch.
b.) FIG. 2 shows the thickness.
c.) FIG. 3 is the three dimensional view of the washer.

4.) Drawing #4—Item #4 Threaded Rod (2 required)
a.) FIG. 1 shows the length at two inches.
b.) FIG. 2 shows major and minor diameters, thread designation of ¼ inch as major diameter and 20 threads per inch.
c.) Note #1 refers to Items 5, 6 and 7 regarding the other lengths required at 3.00, 4.00 and 5.00 inches respectively.
d.) Note #2 states there are 2 pcs. required of each length.

5.) Drawing #5—Item #8 Socket Head Cap Screw (SHCS)
a.) FIG. 1 shows the type of screw head as a Socket Head Cap Screw and the length of the bolt.
b.) FIG. 2 shows the outside diameter of the bolt head, a 3/16 hex configuration for the allen wrench, using a ¼-20 SHCS.
c.) Note #1 refers to Items 8 thru 20. Bolts (SHCS) required of 1.00 thru 4.00 inches in ¼ inch increments.
d.) Note #2 states 2 pcs. required for each length.

6.) Drawing #6—Assembly View (3 dimensional)
a.) FIG. 1 is showing a three dimensional view with a work piece mounted to the fixture base with two 90 degree sides hanging over the two corresponding 90 degree sides of the fixture base, utilizing all five of the items listed in the bill of materials.

1. The Clamp-it-Once fixture is a version of an angle plate, whose main function is to grind components square. The main claim over angle plates is that Clamp-it-Once eliminates the requirement of repositioning the clamps for grinding the second side. Angle plates use proportionally large external clamps that need to be repositioned (due to interference) to grind the second side. Clamp-it-Once has a unique design utilizing small strap clamps that are mounted inboard of the main block eliminating the interference and the additional step of repositioning the clamps saving time and money. Clamp-it-Once has many advantages over angle plates including saving time, money, ease of set-up, easier for multiple pieces, easier to handle and maneuver than traditional angle plates with external clamps.
